(19) United States
(12) Patent Application Publication
(10) Pub. No.: US 2007/0221862 A1
(43) Pub. Date: Sep. 27, 2007

(54) Coupled Electrostatic Ion and Electron Traps for Electron Capture Dissociation - Tandem Mass Spectrometry

(75) Inventors: Arthur Suits, Ann Arbor, MI (US); Myung Hwa Kim, Auburn Hills, MI (US); Brian D. Leskiw, Boardman, OH (US)

Correspondence Address: MILLER IP GROUP, PLC;WAYNE STATE UNIVERSITY, 42690 WOODWARD, SUITE 200, BLOOMFIELD HILLS, MI, 48304, US

(73) Assignee: Wayne State University, Detroit, MI (US)

(21) Appl. No.: 11/676,856

(22) Filed: Feb. 20, 2007

Related U.S. Application Data
(60) Provisional application No. 60/784,633, filed on Mar. 22, 2006.

(51) Int. Cl. H01J 49/00; H01J 27/00

(52) U.S. Cl. 250/427; 250/288

(57) ABSTRACT

A mass spectrometer employing an electrostatic ion trap and electron trap. An ion source generates a stream of ions that are directed into the mass spectrometer. The mass spectrometer includes an ion-focusing region for focusing the ions along a predetermined axis. The focused ions are injected into the electrostatic ion trap where they oscillate between two electrostatic mirror assemblies. A stream of electrons is directed into the electron trap, where the electrons interact with the ions at an interaction region between adjacent electrode assemblies of the ion trap and the electron trap. The interaction between the ions and electrons creates ions, fragments and particles of various masses that can be detected by a pick-up electrode.

### CROSS-REFERENCE TO RELATED APPLICATIONS

This application claims the benefit of the filing date of Provisional Application No. 60/784,633, filed Mar. 22, 2006.

### BACKGROUND OF THE INVENTION

1. Field of the Invention

This invention relates generally to a mass spectrometer employing an electrostatic ion trap and, more particularly, to a mass spectrometer employing an electrostatic ion trap and an electron trap or an ion trap, where cations and electrons or anions interact with each other at a zero relative velocity location at an end of the traps.

2. Discussion of the Related Art

Mass spectrometry is revolutionizing the study of complex molecules. Anticipated advances in biological chemistry and proteomics now hinge on the central contributions of mass spectrometry techniques. Building upon the success of genomics research in the past decade, the goal of proteomics is to analyze and understand all of the protein dynamics in living systems, which is tantamount to a complete chemical understanding of life. The vast complexity of proteins compared to the nucleic acids that code for them, both structurally and with the myriad and ongoing post-translational modifications, means that this task is on an entirely different scale from the genomics effort that preceded it.

Tandem mass spectrometry (tandem MS) is at the heart of all of these advances. Tandem MS refers to the sequential implementation of two or more mass spectrometric techniques, where a particular mass is first selected from a sample, subjected to some chemical or physical interaction, after which the fragment/product ions are subsequently recorded in a second mass spectrum. The resulting spectrum is often quite powerful because it can readily establish primary structure, fragmentation pathways, reaction kinetics, related cross-sections, parent ion stability, and parent-fragment ion correlations.

Despite its successes, numerous obstacles remain for important potential applications for tandem MS. Among these is the lack of well-understood and consistent fragmentation methods to ensure complete and unambiguous parent/fragment ion correlations, the difficulties associated with characterizing a specific complex molecule in a mixture and the need for improved sensitivity and expanded dynamic range. Furthermore, for the quantification and sequencing of proteins, analysis of protein-ligand interactions, and the interpretation of post-translational modification, issues that are central to the expanding field of proteomics, the nature of the fragmentation processes are of particular importance.

Studies to date have largely relied on collision-induced vibrational excitation as an ion fragmentation technique. In these processes, a mechanism is used to break the weak bonds of the materials being analyzed by the collisions to provide various fragmentation patterns. However, information related to the presence and location of post-translational modifications (PTM) is generally lost given the statistical nature of this process and the labile nature of these functionalities. The development of a technique to employ alternative, non-ergodic fragmentation techniques, such as vacuum ultraviolet (VUV) laser photo-fragmentation and electron capture dissociation (ECD), would be beneficial. These processes, although poorly understood, have shown great promise in “top-down” protein sequencing and preserving PTMs, and have recently been demonstrated in a variety of complex configurations involving ion cyclotron resonance, and even RF ion traps. Thus, the full potential of tandem mass spectrometry has not been realized because of the cost and complexity of the current implementations.

One project currently being studied involves the detailed investigation of the interactions between metal ions and nucleic acids. Goals of this work include eludiation of the structural and energetic aspects of metal ion-nucleotide interactions, as well as the development of improved analytical techniques for the structural characterization (sequencing) of nucleic acids by mass spectrometry. In particular, these studies are designed to determine the preferred metal ion binding sites in nucleic acids, the influence that metal ion binding has upon the structure and stability of nucleotides, and the determination of which metal ions best promote specific cleavage of the phosphate ester backbone linkages, and thereby provide the most direct sequence information.

Electron capture dissociation (ECD) is a promising non-ergodic technique of fragmenting proteins that has been shown to preserve many delicate post-translational protein modifications, such as phosphorylation, sulfation O-glycosylation, N-glycosylation, fatty acid modification, methionine oxidation and g-carboxylation. Broad use of ECD has not been possible, however, because it requires expensive and complex Fourier transform ion cyclotron resonance (FT-ICR) mass spectrometers. This is because the interaction time with the electrons must be long and the electron energy must be very low for the electron capture efficiency to be adequate.

Another important alternative “soft” fragmentation mechanism is vacuum ultraviolet (VUV) laser photo-dissociation. This is a relatively unexplored area holding considerable promise as a general non-ergodic fragmentation process readily adaptable to simple electrostatic traps. The F₂ excimer transition at 157 nm (7.9 eV) is an ideal source for this purpose. Easily modeled and general protein fragmentation using a VUV excimer laser can be achieved. These are now readily available commercial laser systems that are not particularly expensive. The potential impact of the demonstration of this approach is quite high indeed. Earlier studies have been reported using an argon fluoride excimer laser (193 nm) to fragment peptides, but this has seen limited interest in that the fragmentation mechanisms are quite different from those in the VUV, the transitions are weaker and the approach is not at all general.

It is unfortunate, but not particularly surprising, that the 157 nm excimer transition has not been widely explored for this purpose. The reasons are several-fold. First, it is only with the recent development of ceramic cavities that these lasers have become at all reliable. Second, VUV laser photo-dissociation requires a vacuum or nitrogen purge for the entire path of the beam and oxygen in air will absorb more than 99% of the light in less than a millimeter path-length. Although it is trivial to implement this, it nevertheless represents a real barrier that has likely inhibited these investigations. Protein chemists and VUV lasers are quite distinct communities.

Electrostatic ion traps are a well-known powerful tool for the analysis of ions, and are quite simple in design and operation. In many respects, electrostatic ion traps may be viewed as two reflectrons coupled together, where the ions behave much like photons in an optical resonator. After being introduced into the trap, the ions are reflected back and forth many thousands of times, possibly for periods as long as hundreds of milliseconds. Ions of different mass propagate at different frequencies inside the trap. A ring pick-up electrode may be used to monitor the ions on each pass with single ion sensitivity. A Fourier transform of the pick-up electrode signal yields the oscillation frequency, which can be converted to an ion mass-to-charge ratio. The resolving power and lifetime of ions in electrostatic ion traps depend highly on the associated trajectories and energetics of the ions, with the overall efficiency of the trap being mass independent. All ions of a given kinetic energy are trapped in stable orbits.

FIG. 1 is a plan view of an electrostatic ion trap 10 positioned within a vacuum chamber of the type discussed above. The ion trap 10 includes an electrostatic mirror assembly 12 at one end of the trap 10 and an electrostatic mirror assembly 14 at an opposite end of the trap 10. The mirror assembly 12 includes a series of annular electrodes 16, here six, that are spaced apart by a suitable distance, and include an aperture 18 that progressively gets larger from a back end of the mirror assembly 12 to a front end of the mirror assembly 12. Electric field lines 20 are shown between the annular electrodes 16. The mirror assembly 14 also includes a series of annular electrodes 22 in the same configuration to provide a mirror image of the assembly 12.

An einzel lens 24 including three cylindrical electrodes 26 is positioned proximate the mirror assembly 12, and an einzel lens 28 including three cylindrical electrodes 30 is positioned proximate the mirror assembly 14. The electric field lines 32 are shown relative to the cylindrical electrodes 26. When the electric field of the assembly 12 is zero, i.e., the electrodes 16 are grounded, ions can be introduced into the cavity between the mirror assemblies 12 and 14. When the electric potential is turned back on for the mirror assembly 12, the ions will oscillate back and forth between the mirror assemblies 12 and 14. As the ions oscillate back and forth between the mirror assemblies 12 and 14, they will momentarily stop at the back end of the mirror assemblies 12 and 14, just before they return back from the direction that they came. The einzel lenses 24 and 28 will collimate the ions to maintain them on the path 34. After some predetermined period of time, for example, 0.5 seconds, the mirror assembly 14 is turned off to allow the ions to escape from the trap 10. The ions are detected by a detector (not shown) so that based on their time-of-flight during the oscillation, the heavier ions will lag behind the lighter ions, and thus the ions can be distinguished by their mass.

One might suspect that energy dispersion in the initial ion packet, Coulomb repulsion between the trapped ions, or slight errors in the electric fields might accumulate and prevent any possibility of long-term trapping with this approach. However, the sustained resolving power of an electrostatic ion trap has been shown to be as high as 10⁴, with ions trapped in very stable orbits for seconds. A similar approach with the release of the ions from the ion trap for time-of-flight (TOF) analysis has been reported in the art and demonstrated a resolving power exceeding 40,000 W.

Using a ring pick-up electrode (not shown), the detection efficiency is constant for all masses, unlike conventional electron multiplier based detectors that fall off in sensitivity with increasing mass, an important issue in proteomics and “top-down” protein analyses. Furthermore, with appropriate integrated amplifiers, single ion detection can be achieved, as mentioned above. These systems promise an extraordinary combination of simplicity, extremely high mass resolution, acute sensitivity and versatility.

### SUMMARY OF THE INVENTION

In accordance with the teachings of the present invention, a mass spectrometer is disclosed that employs an electrostatic ion trap and an electron trap. An ion source generates a stream of ions that are directed into the mass spectrometer. The mass spectrometer includes an ion-focusing region for focusing the ions along a predetermined axis. The focused ions are injected into the electrostatic ion trap where they oscillate between two electrostatic mirror assemblies. A stream of electrons is directed into the electron trap, where the electrons interact with the ions at an interaction region between adjacent electrode assemblies of the ion trap and the electron trap. The interaction between the ions and electrons creates ions, fragments and particles of various masses that can be detected by a pick-up electrode.

Additional features of the present invention will become apparent from the following description and appended claims, taken in conjunction with the accompanying drawings.

### BRIEF DESCRIPTION OF THE DRAWINGS

FIG. 1 is a plan view of a known electrostatic ion trap;

FIG. 2 is a schematic diagram of a mass spectrometer employing an electrostatic ion trap and an electron trap, according to an embodiment of the present invention; and

FIG. 3 is an enlarged view of the electrostatic ion trap and the electron trap from the mass spectrometer shown in FIG. 2.

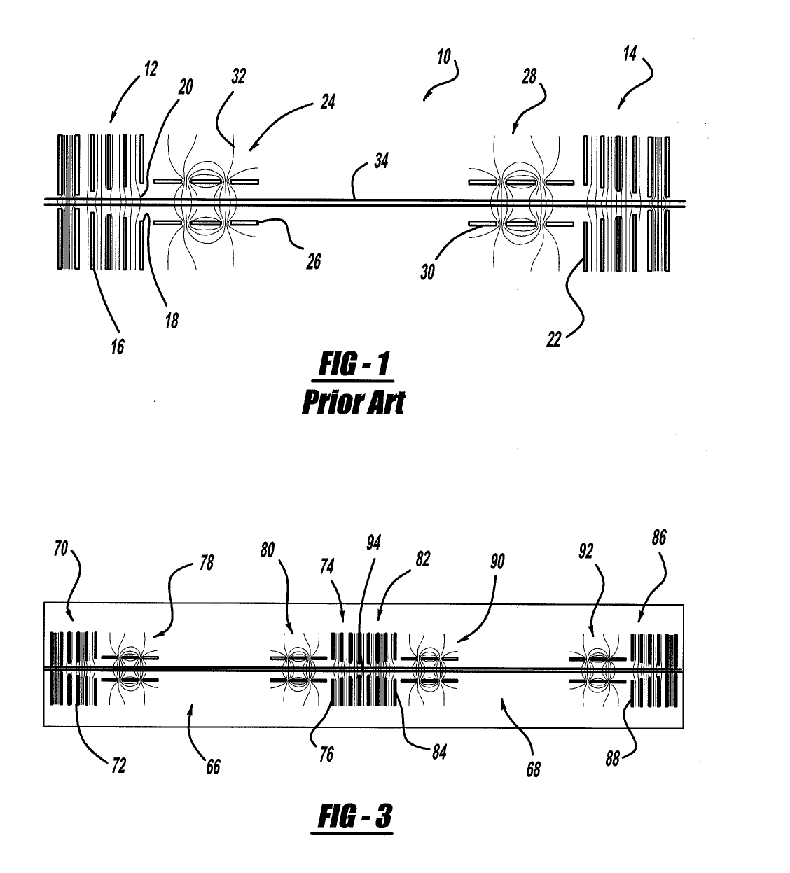

### DETAILED DESCRIPTION OF THE EMBODIMENTS

The following discussion of the embodiments of the invention directed to a mass spectrometer employing an electrostatic ion trap and an electron trap is merely exemplary in nature, and is in no way intended to limit the invention or its applications or uses.

The present invention proposes a tandem mass spectrometer employing an electrostatic ion trap to isolate ions. The proposed spectrometer will be able to establish whether ergodic or non-ergodic dissociation pathways will be most effective for nucleotide sequencing applications by also examining these systems via electron capture or VUV dissociation. As discussed above, broad use of ECD is typically not possible because of limitations to expensive and complex Fourier transform ion site electron resonance mass spectrometers. These are difficult conditions to achieve in conventional quadrupole ion traps. These obstacles may be overcome using simple electrostatic traps with conjoint ion and electron reflectors. This novel aspect of the design is generally important to achieving adequate ECD efficiency.

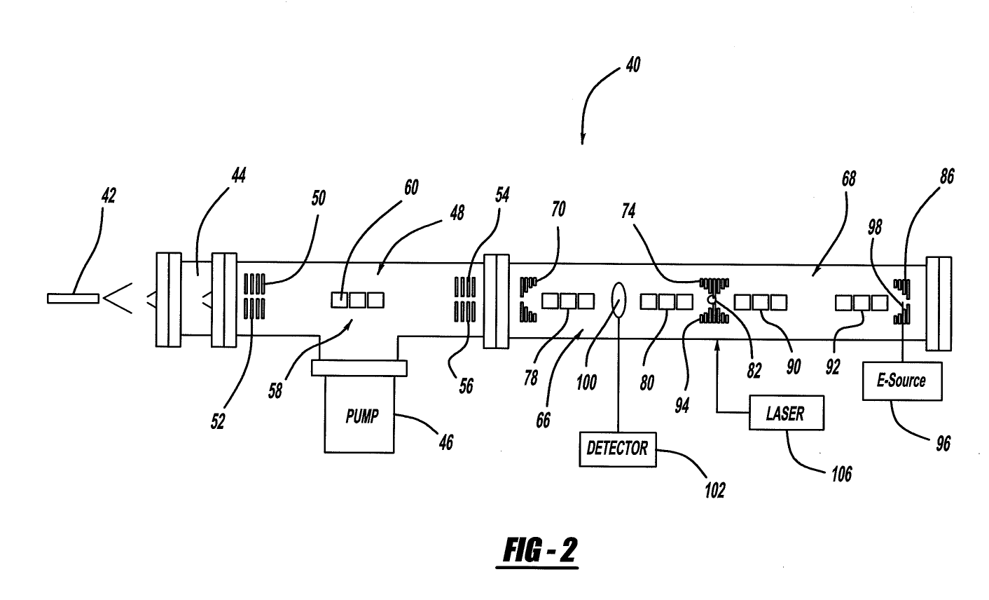

FIG. 2 is a schematic plan view of a mass spectrometer 40, according to an embodiment of the present invention. Multiply charged ions from an ion source 42 are introduced into a vacuum chamber 44 of the mass spectrometer 40. A pump 46 pumps the chamber 44 to a vacuum. The ions are focused by an ion-focusing device 48 to provide a tight stream of the ions. The ion-focusing device 48 includes an electrode assembly 50 having a series of thin annular electrodes 52 at one end of the device 48 and an electrode assembly 54 having a series of thin annular electrodes 56 at an opposite end of the device 48. An einzel lens 58 including three cylinders electrodes 60 collimates the ion beam.

The collimated ion beam is directed into an electrostatic ion trap 66 of the type discussed above. An electron trap 68 is positioned adjacent to the ion trap 66 along the path of the ions, as shown. In an alternate embodiment, the electron trap 68 is an anion trap. FIG. 3 is an enlarged view of the combination of the ion trap 66 and the electron trap 68 removed from the spectrometer 40. As discussed above, the ion trap 66 includes an electrostatic mirror assembly 70 at one end of the trap 66 that include a series of thin annular electrodes 72 whose apertures progressively increase in size. Likewise, an electrostatic mirror assembly 74 including thin annular electrodes 76 is positioned at an opposite end of the trap 66. Einzel lenses 78 and 80 collimate the ions as they are being reflected back and forth between the mirror assemblies 70 and 74.

The electron trap 68 also includes the same configuration of an electrostatic mirror assembly 82 including annular electrodes 84 at one end of the trap 68 and an electrostatic mirror assembly 86 including annular electrodes 88 at an opposite end of the trap 68. Thus, electrons can be made to oscillate within the electron trap 68 between the mirror assemblies 82 and 86. Einzel lenses 90 and 92 collimate the electron stream trapped in the trap 68. Because ions are positively charged and electrons are negatively charged, the electric fields generated by the electrostatic assemblies 82 and 86 and the einzel lenses 90 and 92 would be opposite to the electric fields generated by the electrostatic assemblies 70 and 74 and the einzel lenses 78 and 80.

As is apparent, the electrostatic assembly 74 and the electrostatic assembly 82 are positioned back to back to form one large electrostatic assembly where the annular electrodes with the smallest apertures are at the middle. In this configuration, electrons within the trap 68 and ions within the trap 66 can interact at an interaction region 94 where the speed of the ions and the electrons are at their lowest. Particularly, ions trapped within the ion trap 66 and electrons within the electron trap 68 will have zero relative velocity somewhere in the interaction region 94 because they are stopping to turn direction to pass back through the trap. Because of this low relative velocity, the ions can capture electrons fairly easily, and produce ion fragments and other particles and energy as a result of the interaction process. Those multiply charged ions that capture an electron would still be trapped within the trap 66, but are now daughter ions having a different mass based on the electrons that were captured and the particles that were released.

Returning to FIG. 2, an electron source 96 including a filament 96 injects electrons into the electron trap 68. In an alternate embodiment, the electron source 96 is an anion source. It is not necessary to trap the electrons in the electron trap 68, but merely provide a stream of electrons from the filament 98 that are turned by the electrostatic assembly 82 at the interaction region 94 to have a zero velocity. Therefore, the mirror assembly 86 can be eliminated. A ring pick-up electrode 100 is shown in the path of the ions in the ion trap 66. As the ions travel through the pick-up electrode 100, the electromagnetic interaction with the ring electrode 100 produces a current on the pick-up electrode 100 that can be detected by a detector 102 as a spike. Ions of different mass will oscillate with different frequencies. The detected signal from the pick-up electrode 100 can be Fourier transformed to convert it to the frequency domain, which can be converted to an ion mass-to-charge ratio to identify the ions of a particular mass.

When the initial stream of ions is trapped in the trap 66, the electrostatic assembly 74 can be turned on and off at the appropriate time so that the ions of one mass can be retained in the trap 66 and isolated by releasing the ions of other masses through the electrostatic assembly 74. Once the ions of a particular mass are isolated and trapped within the ion trap 66, the electron source 96 can be turned on to send an electron stream to the interaction region 94 to produce the daughter ions that are detected.

As the ions capture electrons and are fragmented, ions of different masses are generated in addition to the ions of the isolated mass. The ions of the various masses can then be detected by the ring electrode 100 to determine what ions are generated by the electron capture from the original ions.

According to another embodiment of the present invention, a laser 106 directs a laser beam to the interaction region 94 to fragment the ions using heat when they are turning. In this embodiment, the electron trap 68 and the electron source 96 would not be needed because the laser beam provides the fragmentation of the ions. The pick-up electrode 100 would detect the ions in the same manner.

Various ion sources exist in the art with properties providing advantages for particular ions being detected by the spectrometer 10. Suitable ion sources include, but are not limited to, electro-spray ionization sources, electric discharge sources, matrix-assisted laser desorption/ionization (MALDI) sources and laser-induced ionization sources. The sequence of events preceding acceleration and trapping will differ depending on the given application, and thus, which ionization method is used. However, the overall objective for ion introduction is the uniform acceleration of all ions toward the electron trap 68 to achieve uniform kinetic energy. During injection of ions into the trap 66, the potential gradient defining the electrostatic mirror assembly 74 will temporarily be grounded to admit the incoming ion flux. After the ion packet of interest enters the field free region of the trap 68, i.e., any position beyond the last optic of the electrostatic assembly 74, the potential on the electrodes 72 are raised to an appropriate level that matches the potential on the electrostatic assembly 74 on the opposing end. It is noted that ion transmission is proportional to the initial transverse phase space of the ion beam, while the spectrometer 10 is longitudinally dispersive. Thus, there is no conflict in the requirement for high transmission (and sensitivity) and high mass resolution as long as short ion pulses and modest energy spreads can be achieved.

The potential gradient that defines the electrostatic field of the ion trap 68 should maintain axial symmetry, as aberrations may lead to subsequent ion loss. Changing the range of the potential gradient and geometry of each individual electrode 72 and 76 can effectively alter the location of the turning points of the ion orbits. With this in mind, the overlap of the turning ions with a beam of electrons or photons can thus be optimized as described below.

In one embodiment, the electrostatic mirror assemblies consist of eight electrodes, where five of the electrodes are plates (annular electrodes) having concentrically aligned apertures of increasing or decreasing diameter (one of the key improvements over the original design), and three are cylindrical in shape (einzel lenses). The electrostatic field emanating from these three lenses compensates for any radial component of the oscillating ion packet velocity, through collimation and subsequent focusing effects, while the innermost grounded electrode defines the field-free region of the trap 66. The remaining electrodes are responsible for longitudinal capture, and the potential applied to these reflective elements closely resembles a two-state reflectron.

The ability to trap and resolve species of different mass following confinement hinges on one important constraint that all oscillating ions possess the same kinetic energy. Although this requirement may imply limited use over a large mass range, particularly given the kinetic energy dispersion in typical ion sources, it has been shown that the trap 66 will maintain its resolving power even when the kinetic energy requirement is not strictly fulfilled. This is achieved through a sophisticated lens design and through appropriate tuning to induce ion self-bunching and an increased residence time of the ions in the trap 66.

During ion trapping and confinement, the oscillation frequencies of the trapped ions are extracted by analysis of the ring electrode signal. This signal will also provide real-time assessment of the trap performance. It is important to understand that the mass spectrum is obtained by a Fourier transform of the pickup signal, not by time-of-flight. The same strategy is used following fragmentation to obtain the tandem mass spectrum. An initial mass may be selected by lowering one of the electrostatic mirror assembly potentials to clear the other ions, or by adding a small deflection. The ion bunches remain tightly packed and isochronous, so selecting an initial mass or range of masses with high resolution is trivial.

To incorporate ECD or VUV fragmentation, placement of the ECD or VUV device in the field-free region of the trap 66 might seem ideal. In fact, this location is not suitable for a number of reasons. Attempts to identify the subsequent mass fragments would prove difficult or impossible given the partitioning of the kinetic energy from the parent into the fragments and the inability to resolve the various frequencies. In addition, the ion velocities in the field free region are at a maximum, so that interaction time and overlap with the electron or laser beams will be minimal. This is the reason conventional traps are not suitable. Instead, ECD and VUV techniques can be employed inside the electron trap 68 at the turning points. Following the secondary interaction taking place at the turning points, fragment ions will be formed that achieve the same resonant energy characteristic of the trap potentials and their mass-to-charge ratio. Their oscillation frequency as recorded at the pick-up electrode 100 will thus reveal the fragment mass spectrum. There is no time-of-flight or release from the trap 66 necessary to determine the fragment mass spectrum. In addition to maintaining the requirements necessary to resolve the mass of the oscillating ions confined in the trap 66, interrogating select ions at the turning point is ideal, i.e., they have very low kinetic energy, their trajectories are well-defined, and they spend most of their time there.

Electron capture dissociation is an inefficient process whose cross-section rises inversely with kinetic energy, becoming useful RF quadrupole traps, and the reason ICR machines that can achieve low relative energies and long interaction times have been successful in these applications. For use with electrostatic ion traps, an alternative approach is necessary that similarly achieve low electron-ion collision energies and long electron-ion interaction times. It has been shown that very stable ion orbits may be obtained for very long times, and the ion turning point regions are then very well defined. By coupling an electron trap, or an electron mirror, with its turning point the same as the ion turning point, it is possible to continuously bathe the ion turning points with near-zero energy electrons. The average ion-electron relative energies will be determined by the spread in potentials at the turning points. Although this may be several eVs, ions will virtually always encounter some electrons at much lower relative energies, and the ECD excitation function rises steeply toward zero. The electron capture efficiency will thus be determined largely by the average minimum electron-ion energy rather than the overall average collision energy.

There are performed trajectory simulations in the absence of magnetic fields and space charge effects that show successfully trapped electrons for large periods in the conjoined traps, and overlap the turning points very precisely. In practice, a continuous electron beam with the mirror point at the ion turning point can be employed rather than electron traps, so the demands on the electron optics and concerns about stray fields, etc. will be less of an issue. Magnetic fields can also be used to help confine the electron beam if necessary.

As mentioned above, fragmentation of the parent ion induced by electron capture will occur at the turning point, yielding fragment ions that oscillate with the characteristic frequency determined by the trap potential and their mass-to-charge ratio. New signals will appear in the Fourier-transform of the pick-up signal that represent electron capture fragmentation. Although space charge is obviously an issue for electrons at the turning points, the presence of cations there will mitigate the problem.

Charge transfer from anions is an effective alternative to electron capture for non-ergodic cation fragmentation that is gaining wider application. The tandem trap described here can function similarly with trapped anions as with trapped electrons, and in that case the difficulties with using electrons will be eliminated.

Prior work has shown the use of 157 nm laser fragmentation of peptides. Results, obtained in adapted commercial instruments, including both tandem TOF and a linear ion trap machine, have shown the considerable potential of VUV irradiation to yield non-ergodic ion dissociation. A wide variety of fragment types (x-, w- and v-ions) have been observed in dissociation of standard peptides, in contrast to the y- and b-types that dominate the CID spectra. The VUV fragmentation as well as ECD with the electrostatic ion traps can be combined. Laser access at the turning points, as discussed above, will yield fragment ions whose oscillation frequencies reveal their mass-to-charge ratios. It will thus be useful to incorporate a pulsed CO₂ laser for complimentary infrared multiphoton dissociation (IRMPD) fragmentation to contract the non-ergodic fragmentation with ergodic fragmentation mechanisms, or when to achieve more complete fragmentation than is possible with non-ergodic techniques. In addition, VUV and ECD or CO₂ laser fragmentation may be combined in MS³ experiments to confirm fragment identities. This can easily be incorporated into the system for the same reason that the VUV and ECD are straightforward because the ion trajectories are well defined, highly localized and predictable.

In addition to revealing valuable information on the structure and sequence of amino acids in peptides, the direct fragmentation of selected ions will be analyzed using ion-imaging techniques. These methods provide both the fragment identify and the kinetic energy release, and can be a powerful means of revealing the underlying dynamics of the fragmentation mechanism as well as diagnosing and characterizing the performance of the apparatus.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A mass spectrometer comprising:
an ion source for generating a stream of ions;
an electron source for generating a stream of electrons;
an ion trap receiving the stream of ions, said ion trap including a first electrode assembly and a second electrode assembly that receive voltage potentials that create electric fields that trap the ions between the first electrode assembly and the second electrode assembly;
an electron trap receiving the stream of electrons, said electron trap including a third electrode assembly and a fourth electrode assembly that receive voltage potentials that create electric fields that contain the electrons between the third electrode assembly and the fourth electrode assembly, wherein the second electrode assembly and the third electrode assembly are positioned adjacent to each other and define an interaction region therebetween, and wherein the ions in the ion trap and the electrons in the electron trap interact in the interaction region to provide electron capture and ion fragmentation to generate ions of different masses that are trapped in the ion trap; and
a detector for detecting the ions in the ion trap.

2. The mass spectrometer according to claim 1 wherein the detector includes a ring pick-up electrode through which the ions propagate that generates a signal indicative of the ion propagation.

3. The mass spectrometer according to claim 1 wherein the first, second, third and fourth electrode assemblies each include a plurality of annular electrodes having different size apertures.

4. The mass spectrometer according to claim 1 wherein the ion trap and the electron trap include einzel lenses for collimating the ion beam and the electron beam.

5. The mass spectrometer according to claim 1 further comprising an ion-focusing device for focusing the ions into the ion trap.

6. The mass spectrometer according to claim 1 whereon the ion source is selected from the group consisting of electro-spray ionization sources, electric discharge sources, MALDI sources and laser-induced ionization sources.

7. The mass spectrometer according to claim 1 wherein the interaction between the ions and the electrons creates fragments and ions of different masses.

8. The mass spectrometer according to claim 1 wherein the voltage potential applied to the first electrode assembly or the second electrode assembly is selectively turned off and on to release ions from the ion trap and maintain ions in the trap according to their mass.

9. A mass spectrometer comprising:
an ion source for generating a stream of ions;
a charged particle source for generating a stream of charged particles;
an ion trap receiving and trapping ions in the stream of ions, said ion trap including a first electrode assembly and a second electrode assembly that receive voltage potentials that create electric fields that trap the ions between the first electrode assembly and the second electrode assembly where the ions oscillate back and forth between the first and second electrode assemblies;
a charged particle electrode assembly that receives a voltage potential that causes charged particles to be reflected, wherein the second electrode assembly and the charged particle electrode assembly are positioned adjacent to each other and define an interaction region therebetween, and wherein the ions in the ion trap and the charged particles interact in the interaction region to provide ions of different masses that are trapped in the ion trap; and
a detector for detecting the ions in the ion trap.

10. The mass spectrometer according to claim 9 wherein the detector includes a ring pick-up electrode through which the ions propagate.

11. The mass spectrometer according to claim 9 wherein the first, second, and charged particle electrode assemblies each include a plurality of annular electrodes having different size apertures.

12. The mass spectrometer according to claim 9 wherein the interaction between the ions and the charged particles creates ion fragments and ions of different masses.

13. The mass spectrometer according to claim 9 wherein the voltage potential applied to the first electrode assembly or the second electrode assembly is selectively turned off and on to release ions from the ion trap and maintain ions in the trap according to their mass.

14. The mass spectrometer according to claim 9 wherein the charged particle source is an electron source for generating electrons.

15. The mass spectrometer according to claim 9 wherein the charged particle source is an anion source for generating anions.

16. The mass spectrometer according to claim 9 further comprising a charged particle trap for trapping the charged particles, said charged particle electrode assembly being part of the charged particle trap.

17. A mass spectrometer comprising:
an ion source for generating a stream of ions;
an electron source for generating a stream of electrons;
an ion trap receiving the stream of ions, said ion trap including a first electrode assembly and a second electrode assembly that receive voltage potentials that create electric fields that trap the ions in the stream between the first electrode assembly and the second electrode assembly;
a laser source for generating a laser beam, said laser beam being directed towards an end of the second electrode assembly, wherein the ions in the ion trap and the laser beam interact to provide ion fragmentation and ions of different masses that are trapped in the ion trap; and
a detector for detecting the ions in the ion trap.

18. The mass spectrometer according to claim 17 wherein the detector includes a ring pick-up electrode through which the ions propagate.

19. The mass spectrometer according to claim 17 wherein the first and second electrode assemblies each include a plurality of annular electrodes having different size apertures.

20. The mass spectrometer according to claim 17 wherein the ion trap includes einzel lenses for collimating the ion beam.

21. The mass spectrometer according to claim 17 further comprising an ion-focusing device for focusing the ions into the ion trap.

22. The mass spectrometer according to claim 17 whereon the ion source is selected from the group consisting of electro-spray ionization sources, electric discharge sources, MALDI sources and laser-induced ionization sources.

23. The mass spectrometer according to claim 17 wherein the voltage potential applied to the first electrode assembly or the second electrode assembly is selectively turned off and on to release ions from the ion trap and maintain ions in the trap according to their mass.
